(19) United States
(12) Patent Application Publication
(10) Pub. No.: US 2026/0246413 A1
(43) Pub. Date: Aug. 20, 2026

(54) ELECTRIC MACHINE FOR AN AIRCRAFT, COMPRISING AT LEAST ONE MEMBER FOR PROTECTING AGAINST A SHORT CIRCUIT BETWEEN TWO STATOR PHASES, AND PROTECTION METHOD

(71) Applicant: SAFRAN HELICOPTER ENGINES, BORDES (FR)

(72) Inventors: David Bernard Martin LEMAY, MOISSY-CRAMAYEL (FR); Thomas KLONOWSKI, MOISSY-CRAMAYEL (FR)

(21) Appl. No.: 18/871,223

(22) PCT Filed: May 30, 2023
(86) PCT No.: PCT/EP2023/064355

§ 371 Date: Dec. 3, 2024

(30) Foreign Application Priority Data
Jun. 18, 2022 (FR) 2205987

(51) Int. Cl. H02P 29/032; B64D 27/34

(52) U.S. Cl. CPC H02P 29/032; B64D 27/34; H02P 2207/05

(57) ABSTRACT

An electric machine for an aircraft, including a stator including at least three phases each including a winding, a control branch and a neutral branch. The neutral branches being connected together at a neutral point. The electric machine including at least one protection member mounted on the neutral branch of at least one phase. Each protection member including: an inactive state, in which the protection member allows the circulation of the electric current in each phase on which the protection member is mounted, and a protection state, in which the protection member interrupts the circulation of the electric current in each phase on which the protection member is mounted, so as to protect the electric machine in the event of a short circuit.

### TECHNICAL FIELD

This invention relates to the field of electric machines for aircraft and aims to protect an electric machine in the event of a short-circuit between two phases of a stator of an electric machine.

It is well known that electric machines are installed in aircrafts, such as helicopters, to provide a torque, for example to propel the aircraft (motor operation mode), or to generate electric energy (generator operation mode). The electric machines usually used in electrically propelled aircrafts and in hybrid thermal/electric aircrafts are synchronous permanent magnet machines because of their high power density, which allows to limit the on-board weight of the aircraft.

An example of a permanent magnet synchronous machine 300 on board a helicopter is shown schematically in FIG. 1. In a known way, a permanent magnet synchronous machine 300 comprises a stator 100, mounted on a casing element of the aircraft, and a rotor 200, mounted movable in rotation with respect to the stator 100. In this example, the permanent magnet synchronous machine 300 is of the radial flux type, i.e. the rotor 200 comprises a cylindrical shape and the stator 100 extends annularly externally around the rotor 200.

In a known way and with reference to FIGS. 1 and 2, the rotor 200 comprises permanent magnets and the stator comprises several phases 110, generally three phases. Each phase 110 comprises a winding 130, a control branch 120 and a neutral branch 140. The control branches 120 are connected to a power converter 400, usually an inverter/rectifier, and the neutral branches 140 are connected together at a point, designated the neutral point 150. During generator operation, the rotation of the rotor 200 relative to the windings 130 of the stator 100 generates an exciting magnetic flux, which produces an alternating electric voltage between the phases 110.

In practice, as illustrated in FIG. 2, a short-circuit may occur in the electric machine 300 when two windings 130 of the stator 100 come into contact at a point, referred to as the short-circuit point CC. The rotation of the rotor 200 then permanently supplies the circulation of an electric current between the short-circuit point CC and the neutral point 150. As the impedance of the windings 130 is usually low, the electric current increases rapidly, which is likely to cause overheating and damage to the elements of the stator 100.

To reduce this risk, it is known from the patent application FR3057029A1 that the rotation of the rotor of the electric machine may be stopped if a short circuit is detected by adding a mechanical decoupling device, implemented for example by disengagement or by a clutch. Such a device has a high mass, is expensive and difficult to integrate.

Another solution is to size the electric machine to withstand the short-circuit for a sufficient period of time, i.e. until the aircraft lands. It has therefore been proposed to reinforce the windings and/or the insulation, which increases the overall dimension and the mass of the electric machine and reduces its yield in an undesirable way.

It is also known from the patent application FR3091060A1 that hot air is collected from the thermal power generation system and injected into the rotor of the electric machine. This allows the Curie temperature of the permanent magnets to be reached, thereby deactivating their ferromagnetic properties. This solution has the disadvantage of exposing the electric machine to undesirably high temperatures.

It is also known from the patent application US20140268460A1 to add a protection element, such as a fuse, between the neutral point and the coil of each phase, or alternatively on the side of the terminal connector, which blocks the passage of the current in the presence of a short-circuit. In practice, integrating protection elements into the electric machine is proving difficult, as is controlling and maintaining them.

The invention thus aims to protect an electric machine in the event of a short-circuit between two phases of the stator by eliminating at least some of the above-mentioned disadvantages.

### PRESENTATION OF THE INVENTION

The invention relates to an electric machine for an aircraft, comprising a stator and a rotor mounted movable in rotation relative to the stator, said rotor comprising at least one permanent magnet, said stator comprising at least three phases, each phase comprising a winding, a control branch and a neutral branch, said control branches being configured so as to be connected to a power conversion device, said neutral branches being connected together at a neutral point.

The invention is remarkable in that the electric machine comprises at least one protection member mounted on the neutral branch of at least one phase, each protection member comprising:
an inactive state, wherein the protection member allows the circulation of the electric the electric current in each phase on the neutral branch of which the protection member is mounted, and
a protection state, wherein the protection member interrupts the circulation of the electric current in each phase on the neutral branch of which the protection member is mounted, so as to protect the electric machine in the event of a short-circuit.

Thanks to the invention, the circulation of the electric current in one or more phases of the stator is controlled via the protection member, which allows to protect the electric machine in the event of a short-circuit, in particular between two phases of the stator. In contrast to the rotor decoupling device and the hot air circuit of the prior art, each protection member allows to suspend the circulation of the electric current in one or more given phases in a targeted, simple and rapid manner. Protection members such as these may interrupt a short-circuit between two phases, effectively ensuring a protection of elements of the stator from overheating and damage.

According to one aspect of the invention, the stator comprises an outer casing and at least a portion of the neutral branch of each phase on which the protection member is mounted extends externally to the outer casing of the stator. Preferably, the neutral point is positioned externally of the outer casing of the stator. This makes it easier to integrate the protection members, control them and make them accessible for maintenance.

According to one aspect of the invention, the neutral branch of each of a plurality of phases is equipped with a protection member. Preferably, as N designating the number of phases of the stator, the neutral branch of at least N−1 phases is equipped with a protection member. This provides targeted, effective protection for the electric machine, regardless of where the short-circuit occurs between two phases. The electric current may be interrupted in at least one of the two phases where the short-circuit point is located.

According to a first aspect of the invention, the electric machine comprises a plurality of dipolar protection members, each protection member being mounted on the neutral branch of a phase. Dipolar protection members are advantageously simple and inexpensive.

According to a second aspect of the invention, the electric machine comprises a single multipole protection member mounted on the neutral branch of each of a plurality of phases, preferably of all the phases of the stator. The term “multipolar” is used to describe a member comprising more than two electric poles. Advantageously, a single protection member is all that is needed to interrupt the circulation of the electric current in each phase.

According to a preferred aspect of the invention, each protection member comprises a switch for each phase on which the protection member is mounted. Preferably, the switch is in the form of an electromechanical contactor (EMR), a static contactor (SSR) or a pyrotechnic fuse (PSS). Preferably the switch is in the form of a Solid State Power Controller (SSPC). Such a protection member allows the electric current in the phase or phases wherein it is mounted to be interrupted effectively and simply.

According to a preferred aspect of the invention, the electric machine comprises at least one control member configured to activate the protection state of each protection member. The control member ensures the control of the protection members.

According to a preferred aspect of the invention, the electric machine comprises at least one measuring member for measuring the electric current circulating in at least one phase of the stator, preferably the sum of the electric currents circulating in all the phases of the stator. It is advantageous to use such a measuring member to detect a short-circuit and its location at an early stage. A single measuring member for measuring the sum of the electric currents of the phases is advantageously sufficient to monitor all the phases, which limits the overall dimension required.

According to one aspect of the invention, the measuring member is in the form of a magnetic current sensor comprising a magnetic loop surrounding the neutral branch or the control branch of at least one phase of the stator, preferably of all the phases of the stator. This type of measuring member takes up very little overall dimension, making it easy to fit onto the electric machine.

The magnetic current sensor is preferably of the Hall effect type, offering high measurement accuracy and ease of integration.

Preferably, the measuring member is connected to the control member to allow an automatic control of the protection members, based on the monitoring of the electric current in the phases of the phases of the stator.

The invention also relates to the assembly of an electric machine as previously described and a power conversion device, said power conversion device being connected to the control branch of each phase of the stator. Advantageously, the protection members also allow to protect the electric machine in the event of a short-circuit in the power conversion device.

Preferably, the power conversion device is in the form of an inverter/rectifier.

In one aspect of the invention, the power conversion device comprises an outer casing and the neutral point is positioned internally to the outer casing of the power conversion device. This makes it easier to integrate the protection members into the neutral branches and to make them more accessible for maintenance purposes. This also simplifies the control by means of the control member and the measuring member.

The invention also relates to an aircraft comprising an electric machine as described above. Preferably, the aircraft is in the form of a helicopter. Advantageously, the protection members allow to protect the electric machine in the event of a short-circuit in flight, thus avoiding any risk of overheating and damage until the aircraft lands.

The invention also relates to an aircraft comprising an assembly of an electric machine and a power conversion device as described above.

The invention also relates to a method for protecting an electric machine as described above, wherein each protection member is initially in the inactive state so as to allow the electric current to circulate in each phase of the stator, said method comprising:
a step of detecting a short-circuit between two phases of the stator, and
a step of activating the protection state of at least one protection member, in order to interrupt the circulation of the electric current in at least one phase of the stator affected by the short-circuit, so as to protect the electric machine.

The invention also relates to a method for protecting the assembly of an electric machine and a power conversion device as described above, wherein each protection member is initially in the inactive state so as to allow the electric current to circulate in each phase of the stator, said method comprising:
a step of detecting a short-circuit, and
a step of activating the protection state of at least one protection member, in order to interrupt the circulation of the electric current in at least one phase of the stator affected by the short-circuit, so as to protect the electric machine.

Such a protection method is advantageously simple and quick to implement, allowing the electric machine to be protected without waiting if a short-circuit occurs between two stator phases.

### PRESENTATION OF FIGURES

The invention will be better understood on reading the following description, given by way of example, with reference to the following figures, given by way of non-limiting examples, wherein identical references are given to similar objects.

FIG. 1 is a schematic representation of a permanent magnet synchronous machine connected to a power converter according to the prior art.

FIG. 2 is a schematic representation of a short-circuit between two phases of the stator of the permanent magnet synchronous machine shown in FIG. 1,

FIG. 3 is a schematic representation of a permanent magnet synchronous machine connected to a power converter and equipped with protection members according to one embodiment of the invention.

FIG. 4 is a schematic representation of the permanent magnet synchronous machine of FIG. 3 wherein the rotor is not shown.

FIG. 5 is a schematic representation of a method for protecting the permanent magnet synchronous machine of FIG. 3 in the event of a short-circuit between two phases of the stator according to one embodiment of the invention.

FIG. 6 is a schematic representation of a method for protecting the permanent magnet synchronous machine of FIG. 3 in the event of a short-circuit in the power conversion device.

FIG. 7 is a schematic representation of a permanent magnet synchronous machine according to another embodiment of the invention, wherein the rotor has not been shown.

FIG. 8 is a schematic representation of a permanent magnet synchronous machine according to another embodiment of the invention wherein the rotor has not been shown.

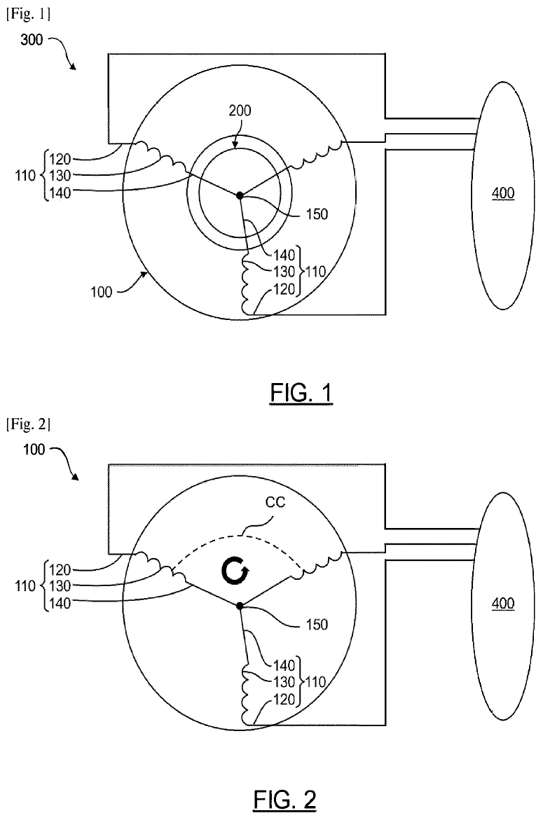

It should be noted that the figures set out the invention in detail in order to implement the invention, said figures of course being able to be used to better define the invention if necessary.

### DETAILED DESCRIPTION OF THE INVENTION

The invention relates to an aircraft comprising one or more electric machines connected to one or more power conversion devices, in order to provide a torque, for example for the propulsion of the aircraft (motor operation mode), or to generate electric energy (generator operation mode). The aircraft is of the electric propulsion or hybrid thermal/electric architecture type. The aircraft is, for example, a helicopter.

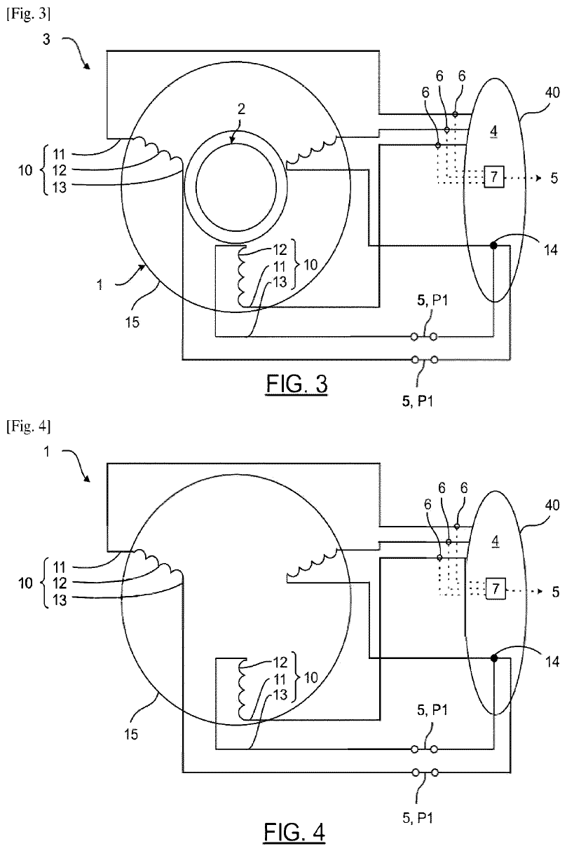

An example of a permanent magnet synchronous machine 3 on board a helicopter is shown schematically in FIG. 3. Advantageously, such an electric machine comprises a high power density, which allows to limit the on-board weight of the aircraft. The electric machine is preferably connected to a power conversion device of the inverter/rectifier 4 type.

As described in the preamble and illustrated in FIG. 3, a permanent magnet synchronous machine 3 comprises a stator 1, mounted on a casing element of the aircraft, and a rotor 2, mounted movable in rotation relative to the stator 1. In this example, the permanent magnet synchronous machine 3 is of the radial flux type, i.e. the rotor 2 comprises a cylindrical shape and the stator 1 extends annularly externally around the rotor 2. The invention also applies in particular to a synchronous machine with permanent magnets of the reverse radial flux type, wherein the stator 1 comprises a cylindrical shape and the rotor 2 extends in an annular manner externally around the stator 1. The invention also applies to a synchronous machine with permanent magnets of the axial flux type, wherein the stator 1 and the rotor 2 comprise a cylindrical shape and extend face-to-face in an axial direction.

As described in the preamble and illustrated in FIG. 3, the rotor 2 comprises permanent magnets and the stator 1 comprises several phases 10, generally three phases. Referring to FIG. 4 (wherein the rotor 2 is not shown for clarity), each phase 10 comprises a winding 12, a control branch 11 and a neutral branch 13. The control branch 11 and the neutral branch 13 extend respectively to the ends of the winding 12. The control branches 11 are connected to the inverter/rectifier 4 and are used to supply the electric machine 3 or to transmit the electric current produced to the inverter/rectifier 4 depending on whether motor or generator operation mode is used. The neutral branches 13 are connected together at a point, referred to as the neutral point 14, forming the mass of the electric machine 3. In generator operation mode, the rotation of the rotor 2 relative to the windings 10 of the stator 1 generates an exciting magnetic flux, giving rise to an alternating electric voltage between the phases 10.

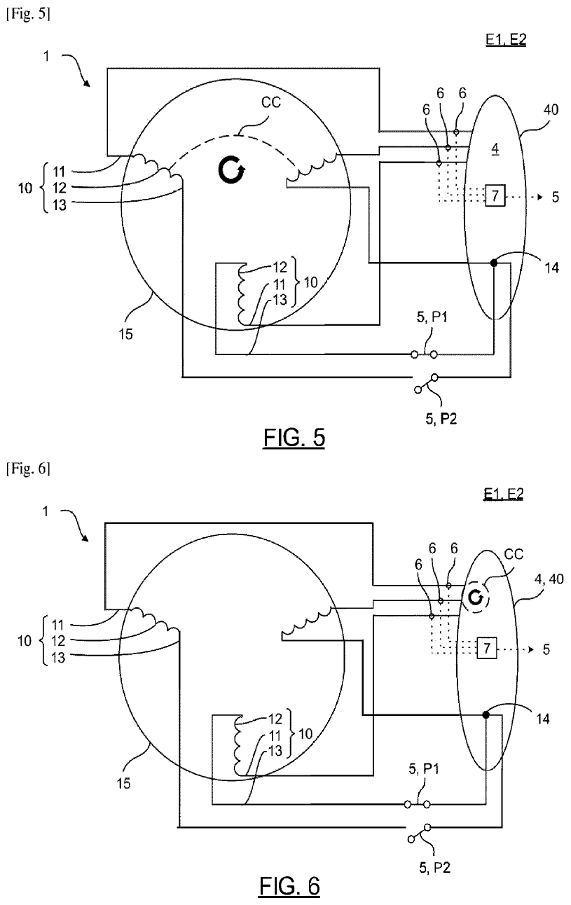

According to the invention and as illustrated in FIGS. 3 and 4, the electric machine 3 comprises one or more protection members 5. Each protection member 5 is mounted on one or more phases 10 of the stator, more specifically on the neutral branch 13 of one or more phases 10. Each protection member 5 comprises an inactive state P1 (see FIG. 3) and a protection state P2 (see FIG. 5). In the inactive state P1, the protection member 5 allows electric current to circulate in each phase 10 on which it is mounted. In the protection state P2, the protection member 5 interrupts the circulation of the electric current in each phase 10 on which it is mounted. In other words, the protection member 5 allows one or more neutral branches 13 to be electrically connected to the neutral point 14 (inactive state P1) or the neutral branch or branches 13 to be electrically disconnected from the neutral point 14 (protection state P2). The protection member 5 therefore acts as a switch.

The integration of protection members 5 in the electric machine 3 advantageously allows to protect the electric machine 3 in the event of the occurrence of a short-circuit CC, in particular between two phases 10 of the stator 1 (see FIG. 5), or even in the power conversion device 4 (see FIG. 6). More specifically, the activation of the protection state P2 allows the neutral point 14 to be opened if a short-circuit occurs, thus avoiding the risks of overheating and damage to the elements of the electric machine 3 and/or the power conversion device 4 caused by the short-circuit.

For all intents and purposes, a short-circuit between two phases 10 of the stator 1 of the electric machine 3 means that the two phases 10 of the stator 1 make contact, for example at the level of the windings 12 in the example in FIG. 5, at a point referred to as the short-circuit point CC. The rotation of the rotor 2 then permanently supplies the circulation of an electric current between the short-circuit point CC and the neutral point 14. As the impedance of the windings 12 is usually low, the electric current increases rapidly and may damage the elements of the electric machine 3. The present invention allows the short-circuit to be interrupted to prevent damage by opening the neutral point 14. The invention also allows to protect against other types of short-circuit, such as those between the power supply harnesses of two different phases 10 of stator 1, or those between two different power transistors of the inverter/rectifier 4.

According to an aspect of the invention illustrated in FIGS. 3, 4 and 8, noting N the number of phases 10 of the stator 1, a number (N−1) or N of neutral branches 13 are equipped with a protection member 5. This effectively allows to protect the elements of the stator 1 wherever the short-circuit occurs by preventing the formation of a current loop. Preferably, (N−1) neutral branches 13 are equipped with a protection member 5 to minimize the mass and the overall dimension requirements with an optimum protection. In practice, a short-circuit affects two phases 10 of the stator 1, and therefore necessarily affects at least one phase 10 equipped with a protection member 5, which is sufficient to interrupt the circulation of the electric current causing the short-circuit. In the example shown in FIGS. 3 and 4 of an electric machine 3 with three phases 10, only two neutral branches 13 are equipped with a protection member 5. In the example shown in FIG. 8, all the neutral branches 13 are equipped with a protection member 5 to suspend the current circulation in all the phases 10.

According to an aspect of the invention illustrated in FIGS. 3, 4 and 8, at least a portion of each neutral branch 13 on which a protection member 5 is mounted extends externally to the outer casing 15 of the stator 1. In other words, the protection members 5, which are functional elements of the stator 1, physically extend outside it. As shown in FIGS. 3, 4 and 8, this is preferably implemented by positioning the neutral point 14 outside the outer casing 15 of the stator 1. The neutral branches 13 thus comprise at least one external portion extending outside the stator 1 and connected together at the level of the neutral point 14. An external mounting of the protection members 5 is advantageously simple and quick, with no overall dimension constraints, and protects the protection members 5 from high temperatures. In addition, this type of mounting makes them easier to access for maintenance.

Preferably, as illustrated in FIGS. 3 and 4, the neutral point 14 extends internally outside 40 of the inverter/rectifier 4. In other words, the neutral point 14, functional element of the stator 1, physically extends into the inverter/rectifier 4. Each neutral branch 13 thus comprises a first end connected to the winding 12 in the stator 1 of the electric machine 3 and a second end connected to the neutral point 14 in the inverter/rectifier 4. Between the first end and the second end, each neutral branch 13 comprises an external portion at which the protection member 5 is mounted. In other words, the protection member 5 extends outside the stator 1 and outside the inverter/rectifier 4, for greater ease of access and installation.

According to a first aspect of the invention illustrated in FIGS. 3 and 4, each protection member 5 is in the form of an electric dipole mounted on a single phase 10 of the stator 1. Preferably, the electric machine 3 comprises N−1 or N protection members 5 each mounted on a phase 10 of the stator 1. Each protection member 5 controls the circulation of the electric current in the phase 10 wherein it is mounted.

According to a second aspect of the invention illustrated in FIG. 8, the electric machine 3 comprises a single protection member 5 in the form of an electric multipole. A multipole refers to a member comprising more than two electric poles. The protection member 5 is mounted in several, preferably all, phases 10 of the stator 1 and is configured to allow each phase 10 on which it is mounted to be interrupted. In the example shown in FIG. 8, the protection member 5 is in the form of a hexapole with three interfaces for mounting on the three phases 10 of the stator 1.

As illustrated in FIGS. 3, 4 and 8, each protection member 5 is a commutator with two different states, namely an inactive state P1 on the one hand and a protection state P2 on the other. The protection state P2 is configured to be triggered only when a short-circuit occurs, the protection member 5 otherwise being in the inactive state P1.

According to a preferred aspect, each protection member 5 comprises a switch for each phase 10 on which it is mounted. In the embodiment shown in FIGS. 3 and 4, each dipolar protection member 5 is in the form of a single switch. In the embodiment shown in FIG. 8 of a multipole protection member 5 for a plurality of phases 10, each multipole protection member 5 comprises an assembly of switches, one per phase, configured to be triggered simultaneously. In one preferred aspect, each switch is in the form of a Solid State Relay (SSR), an Electromechanical Relay (EMR) or a pyrotechnic fuse, also referred to as a pyro-fuse. Preferably, the switch is in the form of a Solid State Power Controller (SSPC), which advantageously has a reduced mass and volume. Such switches are known to the person skilled in the art and are not described further.

According to an aspect of the invention illustrated schematically in FIGS. 3 and 4, the electric machine 3 also comprises a control member 7 configured to control each protection member 5. The control member 7 allows the protection state P2 of each protection member 5 to be activated, the protection member 5 otherwise being in the inactive state P1. Preferably, the control member 7 provides an identical control of each protection member 5 and is configured to simultaneously activate the protection state P2 of each protection member 5, to protect all the phases 10. Preferably, the control member 7 is in the form of a computer. Preferably, the control member 7 is wired to each protection member 5 so as to transmit a control signal to them.

According to one aspect of the invention, the electric machine 3 also comprises one or more measuring members 6 configured to measure a parameter of the electric machine 3, such as the electric current circulating in the phases 10, the speed of rotation of the rotor 2 or the position of the rotor 2. According to a preferred aspect illustrated in FIGS. 3, 4, 7 and 8, the electric machine 3 comprises one or more measuring members 6 for measuring the electric current circulating in the phases 10 of the stator 1. The measuring member 6 is mounted at the level of the control branch 11 (see FIG. 3 and 4) or of the neutral branch 13 (not shown) of at least one phase 10.

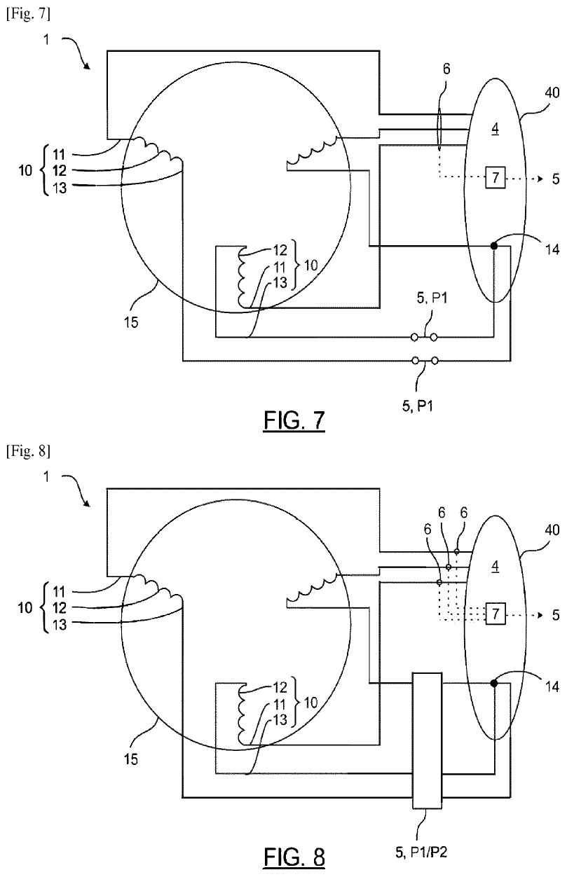

According to a first aspect illustrated in FIGS. 3 and 4, each phase 10 of the stator 1 is equipped with a measuring member 6. Alternatively, one or more phases 10 may be provided without a measuring member 6. According to a second aspect illustrated in FIGS. 7 and 8, the electric machine 3 comprises a single measuring member 6 for measuring the sum of the electric currents circulating in all the phases 10 of the stator 1.

Preferably, with reference to FIGS. 3, 4, 7 and 8, the measuring member 6 is in the form of a magnetic current sensor comprising a magnetic loop surrounding a branch 11, 13 of a phase 10 of the stator 1 (FIG. 7) or a branch 11, 13 of all the phases 10 of the stator 1 (FIG. 8). Preferably, the measuring member 6 is in the form of a Hall-effect sensor.

According to a preferred aspect illustrated in FIGS. 3 and 4, the control member 7 is connected to each measuring member 6 and is configured to detect the occurrence of a short-circuit on the basis of the measurement parameter, such as the electric current. Preferably, the control member 7 is configured to compare the measurement with a predetermined threshold value, stored for example in a database of the control member 7, in order to detect that the threshold has been exceeded. Preferably, the control of the protection members 5 in the protection state P2 is implemented automatically on the basis of the analysis of the measured parameters, which allows a rapid and effective protection. Preferably, the parameters are measured continuously or periodically for an early and automatic detection of the occurrence of a short-circuit. Alternatively, or additionally, the control of the state of the protection members 5 may be implemented manually by an operator.

With reference to FIGS. 5 and 6, the invention also relates to a protection method, wherein each protection member 5 is initially in the inactive state P1 so as to allow the electric current to circulate in each phase 10 of the stator 1 of the electric machine 3, the method comprising:
a step of detecting E1 a short-circuit CC between two phases 10 of the stator 1, and
a step E2 of activating the protection state P2 of a protection member 5, in order to interrupt the circulation of the electric current in a phase 10 of the stator 1 affected by the short-circuit CC.

The protection method is implemented while the electric machine 3 is operating, either as a motor or generator mode. Before the detection step E1, the assembly of the protection members 5 are in the inactive state P1 so as to allow the normal circulation of the electric current in each phase 10 of the stator 1.

With reference to FIG. 5, the detection step E1 is preferably implemented on the basis of one or more measurements of a parameter of the electric machine 3, for example the electric current circulating in each phase 10 of the stator 1 or the sum of the electric currents circulating in all the phases 10. Other parameters may be measured, such as rotation speed and rotor position. The measuring members 6, having acquired these measurements, transmit them to the control member 7, which compares them to a predetermined threshold, with exceeding the threshold corresponding to a short-circuit. Advantageously, such detection is automatic and early. Alternatively or complementary, the detection may also be operated by an operator.

With reference to FIG. 6, the activation step E2 is implemented after the detection step E1, preferably immediately following this step. According to a first aspect of the invention illustrated in FIG. 6, the control member 7 transmits a control signal to the protection member 5 of a phase 10 affected by the short-circuit CC to activate the protection state P2. The other protection members 5 remain in the inactive state P1. Activating the protection state P2 of a single protection member 5 located on the short-circuit loop is advantageously sufficient to interrupt the electric current generated by the short-circuit. In the example shown in FIG. 5, the short-circuit CC affects two phases 10 of the stator 1, one equipped with a protection member 5 and the other without, to minimize the overall dimension. The activation step E2 is thus implemented on the single protection member 5 present on the short-circuit loop. In the case of a short-circuit affecting two phases 10 each equipped with a protection member 5, the activation step E2 may be implemented on one of the two protection members 5 only, and is sufficient to isolate the faulty phase properly. In the case of an electric machine 3 with more than three phases 10, for example five or six. if one phase out of the N phases of the machine is faulty, this also allows operation to continue in a degraded manner on the remaining N-1 phases 10. This allows an electric machine 3 designed to continue to operate as soon as the lost phase is correctly insulated.

Preferably, the detection step E1 also allows to determine the phases 10 of the stator 1 affected by the short-circuit, i.e. the two phases where the short-circuit point CC is located in the example in FIG. 5 of a short-circuit between two windings 12. In the example shown in FIG. 5 of a dedicated measuring member for each phase 10, this is advantageously done on the basis of the position of the measuring members 6 where an abnormal measurement has been taken. FIG. 6 illustrates an example where the short-circuit point appears between two power transistors of the inverter/rectifier 4.

According to a second aspect of the invention, during the activation step E2, the electric current is interrupted in all the phases 10 equipped with a protection member 5. This eliminates the need to locate the short-circuit CC, making a protection even quicker and more reliable. In other words, using the example in FIG. 6, the protection state P2 of each protection member 5 is activated. In the example shown in FIG. 8, the activation of the protection state P2 of the multipole protection member 5 alone allows the electric current to be interrupted in all phases 10.

Following the implementation of the activation step E2, the electric current circulating in the phase 10 of the stator 1 where the protection member 5 is mounted is interrupted. This opens the short-circuit loop, eliminating the risk of overheating and damage to the elements of the stator 1. The advantage of such a solution is that it may be implemented early, simply and quickly, avoiding any undesirable exposure of the elements to heat. In addition, this solution is low cost and easy to integrate, in particular because the neutral point 14 is located outside the electric machine 3.

1. An electric machine for an aircraft, comprising a stator and a rotor mounted movable in rotation relative to the stator, said rotor comprising at least one permanent magnet, said stator comprising an outer casing and at least three phases, each of the phases comprising a winding, a control branch and a neutral branch said control branches being configured so as to be connected to a power conversion device, said neutral branches being connected together at a neutral point, said electric machine further comprising at least one protection member mounted on the neutral branch of at least one of the phases, at least a portion of the neutral branch of each of the phases on which the protection member is mounted extending externally to the outer casing of the stator, the protection member comprising:
an inactive state wherein the protection member allows a circulation of an electric current in each of the phases on the neutral branch of which the protection member is mounted, and
a protection state wherein the protection member interrupts the circulation of the electric current in each of the phases on the neutral branch of which the protection member is mounted, so as to protect the electric machine an event of a short-circuit.

2. The electric machine as claimed in claim 1, wherein the neutral point is positioned externally of the outer casing of the stator.

3. The electric machine according to claim 1, wherein the neutral branch of each of a plurality of the phases is equipped with a the protection member.

4. The electric machine according to claim 1, wherein the protection member of a plurality of the phases is a dipolar protection members mounted on the neutral branch of the phase.

5. The electric machine according to claim 1, wherein the protection member of a plurality of the phases together form a single multipole protection member mounted on the neutral branch of each of the plurality of the phases.

6. The electric machine according to claim 1, wherein the protection member comprises a switch for each phase on which the protection member is mounted.

7. An assembly of the electric machine according to claim 1 and a power conversion device, said power conversion device being connected to the control branch of each of the phases of the stator.

8. The assembly according to claim 7, wherein the power conversion device comprises an outer casing, the neutral point being positioned internally to the outer casing of the power conversion device.

9. An aircraft comprising the electric machine according to claim 1.

10. A method for protecting the electric machine according claim 1, wherein the protection member is initially in the inactive state so as to allow the electric current to circulate in each of the phases of the stator, said method comprising:
detecting a short-circuit between two phases of the stator, and
activating the protection state of at least one protection member, in order to interrupt the circulation of the electric current in at least one phase of the stator affected by the short-circuit, so as to protect the electric machine.

11. The electric machine according to claim 3, wherein the neutral branch of at least N−1 of the phases, with N designating a number of phases of the stator, is equipped with the protection member.

12. The electric machine according to claim 5, wherein the single multipole protection member is mounted on the neutral branch of all of the phases of the stator.

13. The electric machine according to claim 6, wherein the switch is at least one of an electromechanical contactor, a static contactor, and a pyrotechnic fuse.
